(19) United States
(12) Patent Application Publication
(10) Pub. No.: US 2025/0276903 A1
(43) Pub. Date: Sep. 4, 2025

(54) A zero emission process for producing syngas

(71) Applicant: Politecnico di Milano, Milano MI (IT)

(72) Inventors: Flavio MANENTI, Milano MI (IT); Filippo BISOTTI, Milano MI (IT); Kristofer Gunnar PASO, Milano MI (IT)

(21) Appl. No.: 18/857,996

(22) PCT Filed: Apr. 21, 2023
(86) PCT No.: PCT/EP2023/060525

§ 371 Date: Oct. 18, 2024

(30) Foreign Application Priority Data
Apr. 22, 2022 (IT) 102022000008126

(51) Int. Cl. C01B 32/40; B01D 53/26; C01B 32/50; C10J 1/20; C25B 1/042; C25B 9/05; C25B 13/07; C25B 15/021

(52) U.S. Cl. CPC C01B 32/40; B01D 53/265; C01B 32/50; C10J 1/20; C25B 1/042; C25B 9/05; C25B 13/07; C25B 15/021; B01D 2256/22; B01D 2257/80; B01D 2258/0283

(57) ABSTRACT

Process for producing syngas comprising the steps of:
a) burning methane or natural gas with oxygen and optionally with water steam for producing flue gas comprising CO₂ and H₂O according to the following reaction:

$$C {H}_{4} + 2 {O}_{2} \to {CO}_{2} + 2 {H}_{2} O \qquad [ 1 ]$$

b) cooling the flue gas coming from a) by heat exchange with a water stream which is thereby vapourised;
c) condensing and removing water from the flue gas, coming from step b), thereby obtaining a mixture consisting essentially of CO2;
d) carrying out an electrolysis of a steam stream in a solid oxide electrolytic cell (SOEC), whereby steam is split into oxygen gas and hydrogen gas according to the following reaction scheme:

$$H2O ( g ) \to H2 + 1 / 2 O2 \qquad [ 2 ]$$

e) separating and drying hydrogen gas
f) carrying out a reverse water gas shift reaction between CO2 coming from step c) with H2 coming from step e) according to the following scheme:

$$CO2 + H2 \to CO + H2O . \qquad [ 3 ]$$

### FIELD OF THE INVENTION

The present invention relates to a zero-emission process for producing syngas. Specifically, the present invention deals with an autothermal net zero emissions reverse water-gas shift reactor with process electrification for high quality syngas production.

### STATE OF THE ART

It is known to produce syngas in different ways. One of them is the reforming of natural gas according to the overall reaction of steam methane reforming (Quirino et al., 2021, 2020) according to following reaction:

$$CH 4 + {H}_{2} O = CO + 3 {H}_{2}$$

or by means of the autothermal path according to following reaction:

$$C {H}_{4} + 0.5 {O}_{2} = C O + 2 {H}_{2}$$

Another way to generate syngas is the coal (or solid fuel) gasification as in the following simplified lumped scheme:

$$C + {H}_{2} O = C O + {H}_{2}$$

There are also other paths and processes to generate syngas (and hydrogen), such as the reforming of methanol (Palo et al., 2007), the ammonia splitting (Cha et al., 2021), the acid gas to syngas conversion or other sources such as biomasses, biogas, municipal solid wastes, plastic wastes and so on, but no one of them are so widespread and adopted for bulk productions.

In addition, the integration of renewable energy sources is not yet relevant in the production of syngas and, hence, its derivatives (ammonia, methanol, dimethyl ether to quote a few).

The syngas is, in fact, a starting source for generating hydrogen. All the bio and fossil refineries are reforming natural gas as in the above reaction

$$C {H}_{4} + {H}_{2} O = C O + 3 {H}_{2}$$

to obtain syngas and then, shifting the syngas to hydrogen according to the water-gas shift reaction:

$$C O + {H}_{2} O = C {O}_{2} + {H}_{2}$$

If any carbon capture technology is adopted after the shifting, the hydrogen produced assumes the “blue” labelling.

However, the CO₂ to be sequestrated is not only the one generated at the Water Gas Shift Reactor, but also the one (the majority) released as flue gas at the firebox of the steam reformer, caused by the exothermic combustion reaction of methane with oxygen present in air.

$$C {H}_{4} + 2 {O}_{2} = C {O}_{2} + 2 {H}_{2} O$$

heating the tubes, of the steam reformer, wherein the steam endothermic reforming reaction

$$C {H}_{4} + {H}_{2} O = C O + 3 {H}_{2}$$

takes place.

Therefore, the above-described known process presents two main disadvantages the reactor duty generation necessary in the steam reformer for carrying out the endothermal steam reforming reaction and the release of flue gases.

### SUMMARY OF THE INVENTION

In order to overcome the aforementioned problems, a process and a relative plant to produce syngas reducing and preferably avoiding any emission starting from methane (or natural gas), has been conceived.

It is therefore an object of the present invention a process for producing syngas comprising the steps of:
a) burning methane or natural gas with oxygen and optionally with water steam for producing flue gas comprising CO₂ and H₂O according to the following reaction:

$$C {H}_{4} + 2 {O}_{2} \to {CO}_{2} + 2 {H}_{2} O \qquad [ 1 ]$$

b) cooling the flue gas coming from the previous step by heat exchange with a water stream which is thereby vapourised;
c) condensing and removing water from the flue gas, coming from step b), thereby obtaining a mixture consisting essentially of CO₂;
d) carrying out an electrolysis of a steam stream, preferably in a solid oxide electrolytic cell (SOEC), whereby steam is split into oxygen gas and hydrogen gas according to the following reaction scheme:

$${H}_{2} O ( g ) \to {H}_{2} + 1 / 2 {O}_{2} \qquad [ 2 ]$$

e) separating oxygen from Hydrogen and drying hydrogen gas
f) carrying out a reverse water gas shift reaction between CO₂ coming from step c) with H₂ coming from step (e) according to the following scheme:

$$C {O}_{2} + {H}_{2} \to CO + {H}_{2} O . \qquad [ 3 ]$$

Advantageously, the process allows to produce syngas without any emissions starting from methane (or natural gas). Furtherly, the produced CO₂ is directly hydrogenated through a Reverse Water-Gas Shift (RWGS) catalytic bed. It is to be noted that in this way the process and the plant enable to generate high quality syngas reducing the CO₂ overall footprint. The (green) hydrogen for the RWGS process is directly supplied by a Solid Oxide Electrolyser Cell (SOEC) splitting demineralized water into hydrogen and oxygen gas. Thus, this electrolysis allows to furtherly reduce carbon source consumption (i.e., when no blue and/or grey hydrogen are required). The coupling of SOEC and burner units present several benefits:
(i) consuming lower amounts of fossil fuels,
(ii) exploiting green hydrogen for CO₂ hydrogenation, and
(iii) reducing to zero greenhouse gases (GHG) emissions.

### DESCRIPTION OF DRAWINGS

FIG. 1: is a block flow diagram of plant units according to the present invention;

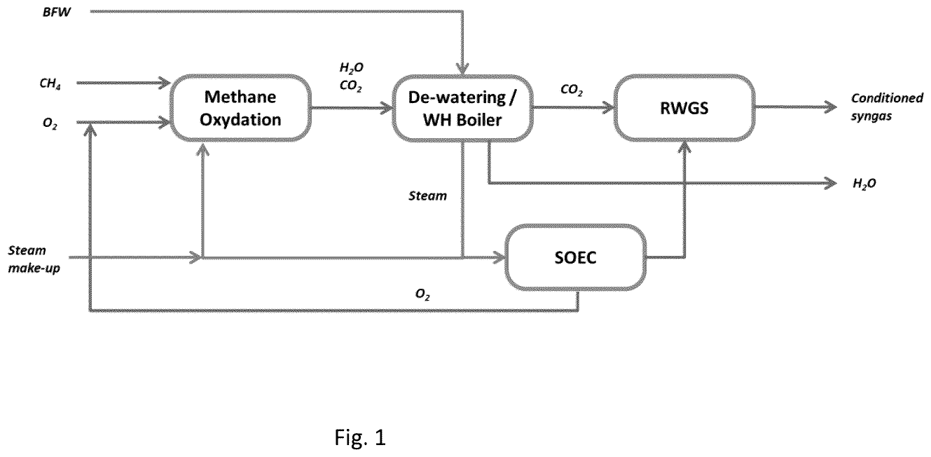

FIG. 2: is a schematic representation of a preferred embodiment of the plant according to the present invention;

FIG. 3 reports in table 1 the steam spreadsheet for the plant of FIG. 2 obtained by conducting Aspen Hysys v11 simulation.

FIG. 4 reports in table 2 the stream composition and in table 3 the duties of the plant of FIG. 2 obtained by conducting Aspen Hysys v11 simulation.

FIG. 5 represents a schematic representation of the plant according to a further preferred embodiment.

FIG. 6 reports in Table 4 the steam spreadsheet for the plant of FIG. 5 obtained by conducting Aspen Hysys v11 simulation.

FIG. 7 reports in Table 5 the stream compositions and in table 6 the duties of the plant of FIG. 5 obtained by conducting Aspen Hysys v11 simulation.

### DETAILED DESCRIPTION

For the purposes of the present invention the wording “comprising” does not exclude the possibility that further stages/elements not explicitly listed after said wording are contemplated.

On the contrary the wording “consisting of” excludes the above possibility.

For the purposes of the present invention the wording “plant” means an assembly comprising one or more reactive and/or operating units in fluid and/or thermal communication among each other.

For the purposes of the invention with the wording “reactive units” we mean reactors.

For the purposes of the invention for operating units we mean heat exchanger, pumps, separators, condenser etc.

The present invention further relates to a plant for carrying out the process according to the present invention, comprising:
a burner unit (OXY STEAM COMB.);
a solid electrolytic cell (SOEC)
a reverse water gas shift reactive unit (RWGS).

The burner unit is connected to the RWGS reactive unit through a waste heat boiler (Boiler) and a water condensation unit (De-wa1),

The SOEC is connected to the RWGS reactive unit through to a separator or splitting unit (SEP) and a further water condensation unit (De-waH2) being downstream the SOEC. It is to be noted that the process of the present invention and the relative plant can be applied to all the processes aimed at producing bulk organic chemicals, syngas and derivates, hydrogen for example but not limiting in the field of application of methanol, ammonia, dimethyl ether, acetic acid, hydrogen, polymers, methanol to olefins, hydrogenation, hydrotreatments, formylation, carbonylation.

Advantageously, the process and the plant of the present invention allow to product syngas with zero flue gases emissions.

Advantageously, the process and the plant of the present invention using the autothermal unit in step (a), avoids using firebox.

Advantageously, the process and the plant of the present invention allow through the electrification production of syngas zero environmental impact.

Advantageously, the process and the plant of the present invention allow to produce conditioned syngas (ready for synthesis) without any CO₂ capture plant, amine washing, sweetening or other technologies.

Advantageously, the plant of the present invention can be chemically and thermally integrated with existing plants.

For the purposes of the present invention, the definition of “chemically integrated” means that the streams leaving one unit of the plant of the invention are partially/completely used as reactants in the existing plant and viceversa. For the purposes of the present invention, the definition of “thermally integrated” means that the thermal energy produced in one of the units of the plant of the invention is used for the operation of another unit of the existing problem and viceversa.

Preferably in the process of the invention step a) is carried out in the presence of steam for producing flue gas comprising CO₂ and H₂O according to reaction [1].

In this way it is possible to mitigate the temperature of the flue gas produced at a temperature range of from 1050 to 1200° C., preferably with a mass ratio of methane, O₂ and water steam ranging from 1:4:7 to 1:4:9, preferably is 1:3.97:7.2. at a pressure comprised between 20 and 40 bar, preferably 30 bar, Preferably the molar ratios of methane, O₂ and water steam respect the optimal values reported in Seepana and Jayanti (Seepana and Jayanti, 2010).

Preferably the oxygen is fed to the step a) from an oxygen external source such as an oxygen tank or an air separation unit and/or the step e).

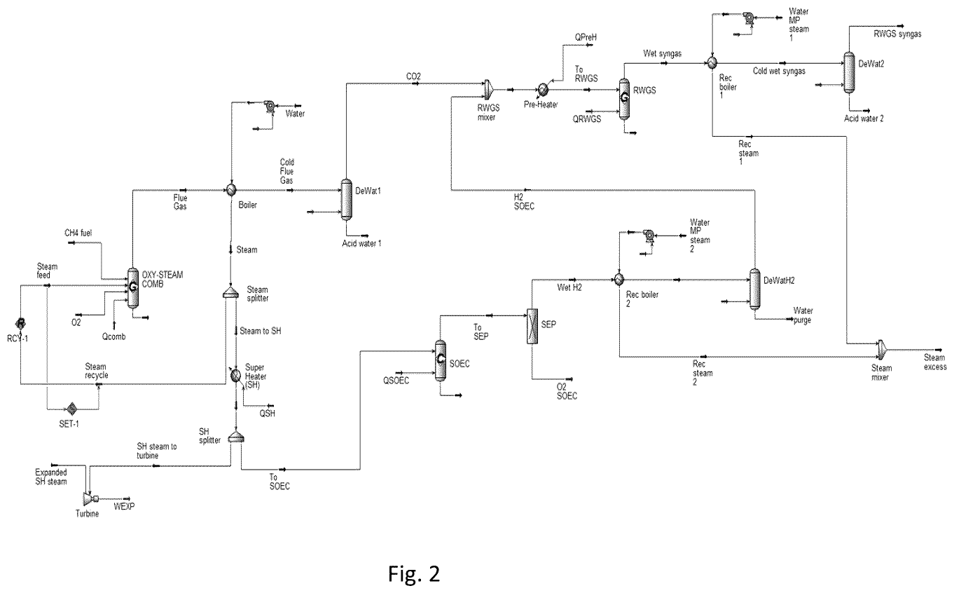

For example, in the in the preferred embodiment reported in FIG. 2 the oxygen fed at the step a) comes in part from the one produced in the step e).

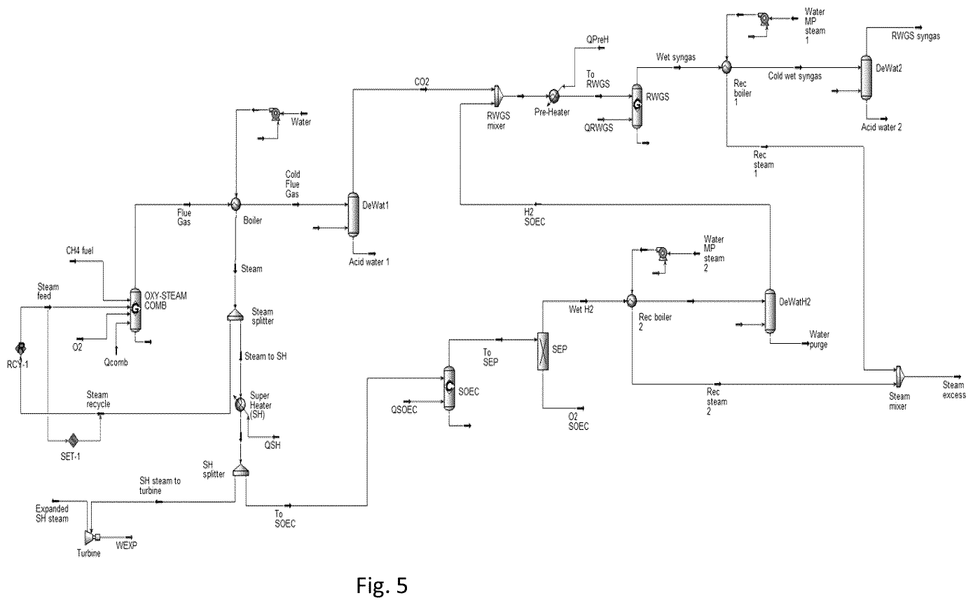

According to another preferred embodiment reported in FIG. 5 Oxygen fed to step a) comes entirely from step e).

According to one embodiment, step b) is carried out in a waste heat boiler wherein the hot flue gas coming from step a) enters the tube side causing fed water stream at the shell side to boil generating medium pressure (MP) steam of from 20 to 40 bar, preferably 30 bar. Specifically, the heat of the flue gas is recovered to heat the water steam up to the vaporization and to cool the flue gas for the following steps.

Specifically, the medium pressure steam leaving the waste heat boiler is split into two streams whereby the first one is sent to step a) according to the embodiment wherein the step a) receives steam. Such first stream is used to support the burning reaction. The second stream of medium pressure is previously heated to a temperature comprised between 500 and 600° C., preferably 550° C., is further split into two streams, wherein the first one is expanded in a turbine, and the second one is sent to step d).

Preferably, the second stream sent to the step d) is further heated to a temperature comprised between 800 and 900° C., preferably 850° C. before entering step d) to adjust the hydrogen content in the quality syngas stream.

The process comprises the step c) of condensing and removing water from the flue gas, coming from step b), thereby obtaining a stream consisting essentially of CO₂. Preferably, during step c) the flue gas is previously cooled before removing water. Specifically, the flue gas in the step c) is exploited in a dewatering unit.

The process comprises the step d) wherein an electrolysis of a steam stream is carried out in a solid oxide electrolytic cell (SOEC), whereby steam is split into oxygen gas and hydrogen gas according to the reaction scheme [2]. Namely, a portion of the medium pressure steam is used to generate oxygen and hydrogen. According to alternative embodiments, the electrolysis can be carried on with known device other than solid oxide electrolytic cell to produce oxygen and hydrogen such as for example: Polymer Electrolytic Membrane (PEM) or alkaline cells.

As anticipated the oxygen generated in the step d) after separation from the hydrogen can be sent to the step a) for reducing the oxygen demand form the reservoir in order to obtain a self-sustainable burning process. The hydrogen instead can be used for the following steps after step e).

Preferably the step d) is carried out at a temperature comprised between 800 and 900° C. preferably at 850° C., at a pressure comprised between 20 and 40 bar, preferably 30 bar.

The process comprises the step e) separating and drying hydrogen gas. Specifically, the step e) allows to separate oxygen and hydrogen generated in the step d). The oxygen stream is sent to the step a) for the burning step while the hydrogen stream is sent to the step f) for producing syngas. In detail, the hydrogen stream is pre-treated to reduce the content of water by means of a dewatering unit. It is to be noted that to optimize the removal of water the hydrogen stream is firstly cooled. In addition, the heat of the hydrogen stream is used to generate a high-pressure steam at about 30 bars to be used in the process of invention and/or in an integrated plant to produce energy or other products.

Preferably, the hydrogen stream generated at the step e) to be sent to the step f) is almost pure hydrogen over 99,5%.

The process comprises the step f) wherein a reverse water gas shift reaction is carried out between CO₂ coming from step c) with H₂ coming from step e) according to the scheme [3]. Specifically, in the step f) humid conditioned syngas is produced due to the reaction [3] between the H₂ from the step e) and CO₂ from the step c). In detail, the reverse water gas shift reaction reduces CO₂ to CO to obtain humid conditioned syngas.

According to one embodiment, the reverse water-gas shift reaction at step f) take place in a catalytic tube bundle at a temperature comprised between 80° and 900° C. preferably at 850° C., at a pressure comprised between 20 and 40 bar, preferably 30 bar. Namely, the CO₂ and H₂ streams are mixed during the step f) and heated at a temperature range tween 800 and 900° C. preferably at 850° C. Preferably the heat to reach the reaction temperature during the step f) can derive from the exothermic reaction at the step a).

Preferably, in step f) hydrogen is preferably fed in molar ratio with respect to CO₂ comprised preferably between 3.0 and 5.5 more preferably between 3.1 and 5.0.

According to one embodiment, the process comprises a step g) of de-watering wet syngas coming from step e) for separating H₂O from the syngas. Preferably, dry syngas has a ratio H₂/CO ranging from 3.0 to 5.5, preferably between 3.1 and 5.0. It is to be noted that the step g) can be preceded by a cooling step, in order to recover the wet syngas enthalpy by generating high-pressure steam at 30 bars by means of the heat exchanger. The cooled down wet syngas is sent to the step g) in a dewatering unit to reduce the water content.

It is a further object of the present invention a plant for producing syngas configured to carry out the process of the invention. It is to be noted that it is clear from the context in which units the steps of the process are carried out.

The plant comprises a burner unit configured to carry on the step a) preferably the burner unit comprises a furnace. The burner unit is configured to receive methane or natural gas, oxygen and preferably also steam. Namely, the burner unit can be put in fluid communication with methane or natural gas production plant, with an oxygen source such as a reservoir and/or oxygen production unit and with steam source such as other unit which produce steam.

The plant comprises a waste heat boiler comprising a plurality of tubes surrounded by a shell. The waste heat boiler is configured to carry out step b). Specifically, the waste heat boiler is directly connected with the burner unit to receive the flue gas in the tube side and directly connected with a source water unit to receive the water stream in the shell side. In this way, the waste heat boiler allows the heat exchange.

The plant comprises a water condensation unit connected to the burner unit through the waste heat boiler. The water condensation unit is configured to carry our step c) to produce the mixture consisting essentially of CO₂. Preferably, the first water condensation unit can be connected to a first heat-exchange unit to cool down the flue gas before or during the de-watering.

The solid oxide electrolytic cell is configured to carry out step d) producing oxygen and hydrogen streams. Specifically, the solid oxide electrolytic cell upon production of the oxygen and hydrogen streams is configured to send oxygen stream to the burner unit and the hydrogen stream to the reverse water gas shift reactor unit.

It is to be noted that, the solid oxide electrolytic cell is preferably connected to a first splitting unit and a further water condensation unit that are configured to separate the oxygen and hydrogen streams and then to de-watering the hydrogen stream to be sent to the reverse water gas shift reactor unit. Namely, in the solid oxide electrolytic cell provided with the splitting unit and the further de-watering unit allows to carry out both steps d) and e) of the process of the invention.

It is to be noted that the plant can comprise a heat exchange unit cooling humid hydrogen coming from the separation unit and before entering the dewatering unit wherein pure hydrogen is obtained.

Also, this heat exchanger uses as cooling fluid a water stream that in said heat exchanger is transformed into high-pressure steam.

Preferably the plant comprises a second splitting unit configured to split the medium pressure steam coming from the waste heat boiler in a first steam stream to be sent to the burner unit and a second steam stream to be sent to SOEC. The plant further comprises a second heating unit configured to heat the second stream before it reaches the solid oxide electrolytic cell. Preferably, the plant comprises a third splitting unit configured to split the previous second stream into a first stream to be sent to a turbine and a second stream to be sent to the solid oxide electrolytic cell. More preferably, the plant comprises a third heating unit configured heat the second stream of the steam before it reaches the solid oxide electrolytic cell.

The plant comprises a reverse water gas shift reactor unit directly connected with the first water condensation unit and the solid oxide electrolysis unit. The reverse water gas shift reactor unit is configured to carry out the step f) producing the syngas. Specifically, the reverse water gas shift reactor unit is configured to heat the mixture up to reaction temperature to convert CO₂ to CO with generation of water.

According to one embodiment, the plant comprises a second de-watering unit directly connected with the reverse water gas shift reactor unit. The second dewatering unit is configured to carry out step g) receiving the wet syngas for splitting H₂O from the syngas.

Preferably, the plant comprises a fourth heat exchange unit configured to act on the syngas generated from the reverse water gas shift reactor unit and before it enters in the second water condensation unit. The fourth heat exchange unit is configured to produce high-pressure steam.

It is to be noted that the high-pressure steam produced in the plant and the energy from the turbine can be used in the plant itself for the self-consistency and/or to reduce the used resources and/or to support other process and plant associated to the ones of the present inventions.

### Example 1

A preferred embodiment of the plant according to the present invention is depicted in detail in FIG. 2. Apart from energy/process integration, the layout includes all the relevant unit operations and reactions. The methane (CH4_fuel), steam (Steam_in), and oxygen (O2_in) are burnt in the furnace burners (OXY-STEAM COMB) where the steam-moderated oxy-fuel combustion (SMOC) occurs. The relative ratios among these three streams reflect the optimal reported in Seepana and Jayanti (Seepana and Jayanti, 2010). The heat of the exiting flue gas (FlueGas) is recovered in a waste heat boiler where pressurized water (stream 6) is vaporized at 30 bars (a). The cold flue gas (ColdFG) is then cooled in a dewatering unit (DeWat1) where almost dry CO₂ leaves the unit (CO₂). In the first splitter (TEE-101) a fraction of the saturated steam (Steam1) is directly recirculated to the burners to sustain the SMOC, the remaining part (Steam_to_split) is furtherly heated to 550° C. In the second splitter (TEE-100), the superheated steam is split into two streams: one fraction (SHSteam_highP) is expanded into a turbine (K-110) while the complementary fraction (ToSH2) is furtherly pre-heated up to 850° C. in the economizer (E-105). The latter stream (ToSH2) is selected to adjust the hydrogen content in the quality syngas stream (RWGS_syngas). The superheated steam (ToSOEC) is then split within the SOEC. In FIG. 2, the SOEC electrolyser is schematized as a conversion reactor (SOEC) and a generic splitter (X-100). The pure oxygen (O2SOEC) can be recirculated to the furnace burner to furtherly reduce the oxygen demand, while the hydrogen-rich stream (H2_SOEC) is cooled (E-102) and then dried in a dewatering vessel (DeWat_H2). Almost pure hydrogen (99.85%) leaves the dewatering flash unit. The recovery heat is exploited to generate high-pressure steam (HPS) at 30 bars (Steam2). The pure CO2 and hydrogen (H2) are mixed and the resulting stream (stream 1) is preheated up to 850° C. The RWGS reaction takes place in a catalytic tube bundle where heat is supplied thanks to the exothermic SMOC. The wet syngas mixture (Wet_syngas) is quenched. The heat exchanger (E-103) enables to recover wet syngas enthalpy by generating HPS at 30 bars. The cooled stream (Wet_syngas_out) is sent to a dewatering process to reduce the water content (DeWat2). The final dry quality syngas (RWGS_syngas) present the optimal composition for the methanol synthesis (SN=2.05 and H₂/CO>3) (Løvik et al., 2001).

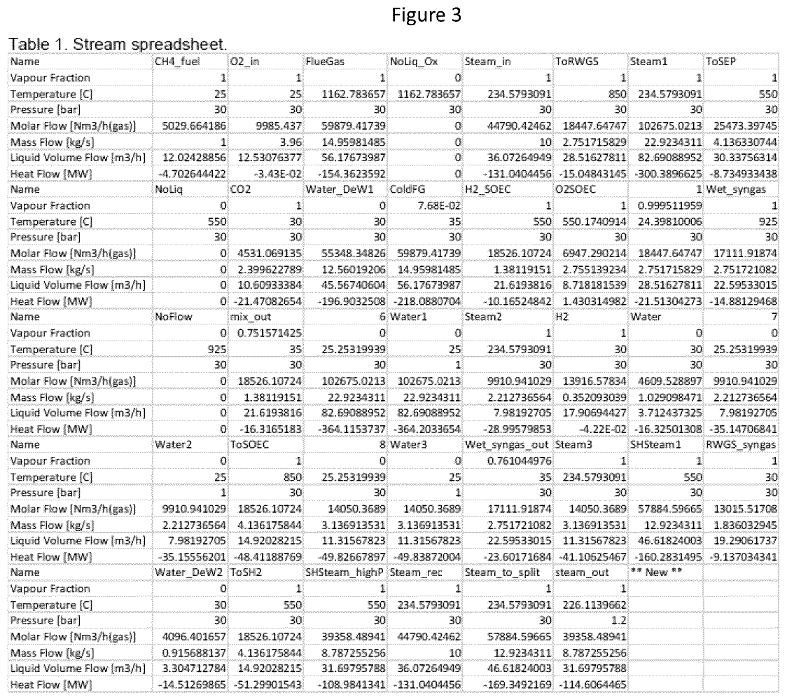

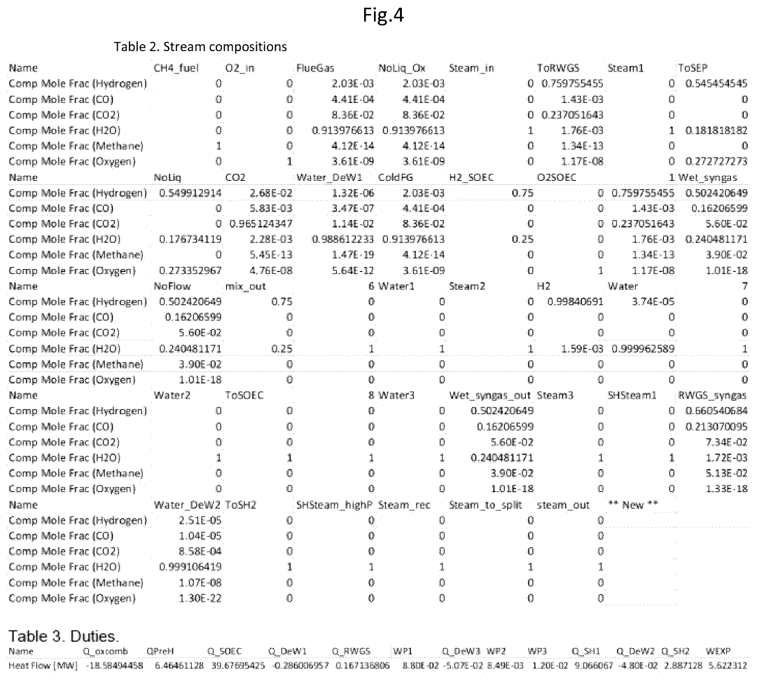

The stream spreadsheet of the plant of FIG. 2 resulting from Aspen Hysys v11 simulation is given in Table 1 reported in FIG. 3, Table 2 illustrates the composition of the streams; and Table 3 illustrates the duties reported in FIG. 4 resulting from Aspen Hysys v11 simulation.

### Example 2

A further preferred embodiment is reported of the plant according to the present invention is represented in FIG. 5 differing from that reported in FIG. 2 in the SOEC section. Indeed, the SOEC electrolysers produce the overall oxygen requirement for the SMOC system. Hence, the oxygen production is directly supplied to the burner in the furnace. This means, that external oxygen suppliers (i.e., oxygen tank or Air Separation Unit) are no longer required. The internal complete oxygen demand recovery is reflected in a larger final hydrogen content. The final dry syngas is closer to the conventional industrial mixture composition even though it is not optimized for the methanol production.

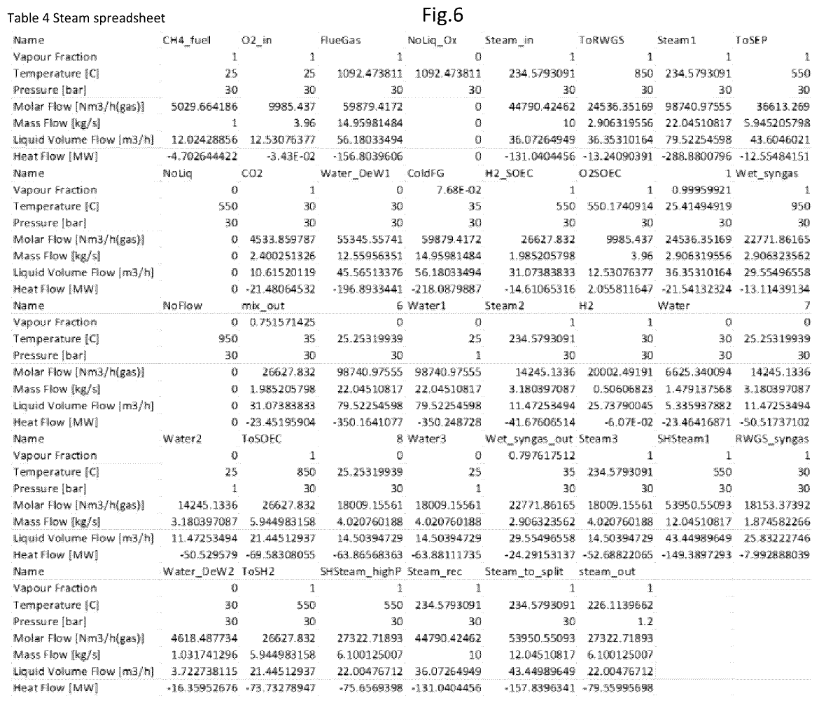

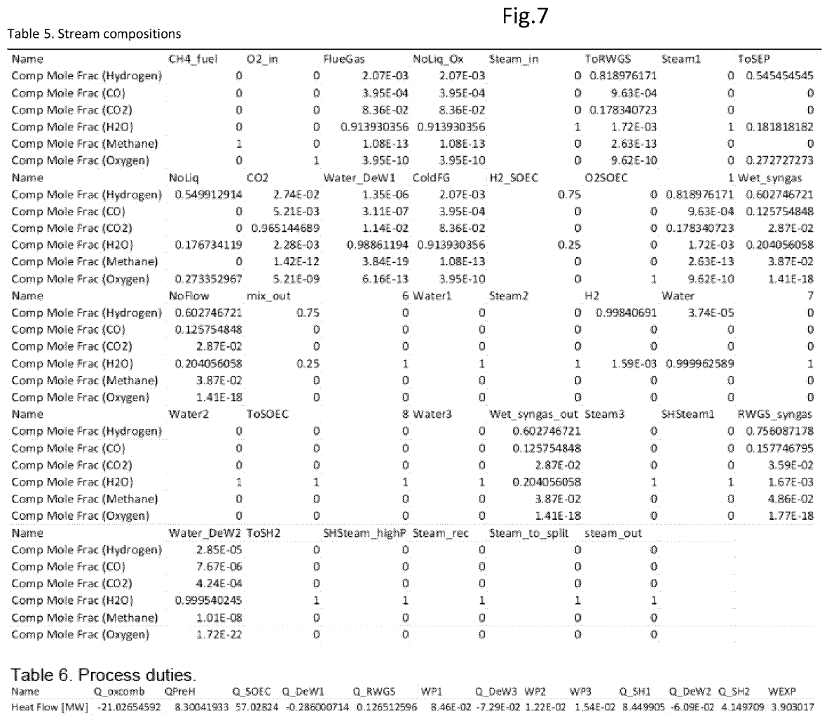

The stream spreadsheet of the plant of FIG. 5 resulting from Aspen Hysys v11 simulation is given in Table 4 reported in FIG. 6. As reported in FIG. 7 Table 5 illustrates the composition of the streams; and Table 6 illustrates the duties-resulting from Aspen Hysys v 11 simulation.

### BIBLIOGRAPHY

Bassani, A., Pirola, C., Maggio, E., Pettinau, A., Frau, C., Bozzano, G., Pierucci, S., Ranzi, E., Manenti,F., 2016. Acid Gas to Syngas (AG2S™) technology applied to solid fuel gasification: Cutting H2S and CO₂ emissions by improving syngas production. Appl. Energy 184, 1284-1291.https://doi.org/https://doi.org/10.1016/j.apenergy.2016.06.040
Cha, J., Park, Y., Brigljević, B., Lee, B., Lim, D., Lee, T., Jeong, H., Kim, Y., Sohn, H., Mikulčić, H., Lee, K. M., Nam, D. H., Lee, K. B., Lim, H., Yoon, C. W., Jo, Y. S., 2021. An efficient process forsustainable and scalable hydrogen production from green ammonia. Renew. Sustain. Energy Rev.152. https://doi.org/10.1016/j.rser.2021.111562
Palo, D. R., Dagle, R. A., Holladay, J. D., 2007. Methanol steam reforming for hydrogen production. Chem.Rev. 107, 3992-4021. https://doi.org/10.1021/cr050198b
Quirino, P.P.S., Amaral, A., Pontes, K. V., Rossi, F., Manenti, F., 2021. Impact of kinetic models in the prediction accuracy of an industrial steam methane reforming unit. Comput. Chem. Eng. 152, 107379. https://doi.org/10.1016/j.compchemeng.2021.107379
Quirino, P.P.S., Amaral, A., Pontes, K. V., Rossi, F., Manenti, F., 2020. Modeling and Simulation of an Industrial Top-Fired Methane Steam Reforming Unit. Ind. Eng. Chem. Res. 59, 11250-11264.https://doi.org/10.1021/acs.iecr.0c00456
Løvik, I., Rønnekleiv, M., Olsvik, O., Hertzberg, T., 2001. Estimation of a deactivation model for the methanol synthesis catalyst from historic process data, in: Gani, R.,
Jørgensen, S.B.B.T.-C.A.C.E. (Eds.), European Symposium on Computer Aided Process Engineering-11. Elsevier, pp. 219-224. https://doi.org/https://doi.org/10.1016/S1570-7946 (01) 80032-8 Seepana, S., Jayanti, S., 2010. Steam-moderated oxy-fuel combustion. Energy Convers. Manag. 51,1981-1988. https://doi.org/10.1016/j.enconman.2010.02.031.

1. A process for producing syngas comprising the steps of:
a) burning methane or natural gas with oxygen and optionally with water steam for producing flue gas comprising CO₂ and H₂O according to the following reaction:
$$C {H}_{4} + 2 {O}_{2 -} \to {CO}_{2} + 2 {H}_{2} O \qquad [ 1 ]$$
b) cooling the flue gas coming from the previous step by heat exchange with a water stream which is thereby vapourised.
c) condensing and removing water from the flue gas, coming from step b), thereby obtaining a mixture consisting essentially of CO₂;
d) carrying out an electrolysis of a steam stream, [preferably in a solid oxide electrolytic cell (SOEC)], whereby steam is split into oxygen gas and hydrogen gas according to the following reaction scheme:
$${H}_{2} O ( g ) \to {H}_{2} + 1 / 2 {O}_{2} \qquad [ 2 ]$$
e) separating oxygen from hydrogen and drying hydrogen gas,
f) carrying out a reverse water gas shift reaction between CO₂ coming from step c) with H2 coming from step (e) according to the following scheme:
$$C {O}_{2} + {H}_{2} \to CO + {H}_{2} O . \qquad [ 3 ]$$

2. The process according to claim 1, wherein O2 fed to step a), partly comes from an oxygen external source and the remaining part from step e)

3. The process according to claim 1, wherein the entire O₂ fed in step a) comes from step e).

4. The process according to claim 1, wherein step a) is carried out in the presence of steam, and in step a) a steam-moderated oxy-fuel combustion is carried out at a temperature ranging from 1050 to 1200° C. a wherein the mass ratio of Methane, O₂ and water steam ranges from 1:4:7 to 1:4:9.

5. The process according to claim 1, wherein the step b) is carried out in a waste heat boiler, wherein the hot flue gas coming from step a) enters the tube side causing fed water stream at the shell side to boil, generating medium pressure (MP) steam of from 20 to 40 bar.

6. The process according to claim 5 wherein said medium pressure steam leaving said waste heat boiler is split into two streams whereby the first one is sent to step a), whereas the second one previously heated at a temperature comprised between 50° and 600° C., is further split into two streams, wherein the first one is expanded in a turbine, and the second one is sent to step d).

7. The process according to claim 1, wherein step d) is carried out at a temperature comprised between 80° and 900° C., at a pressure comprised between 20 and 40 bar

8. The process according to claim 1, wherein the reverse water-gas shift reaction at step f) takes place in a catalytic tube bundle at a temperature comprised between 80° and 900° C., at a pressure comprised between 20 and 40 bar.

9. The process according to claim 1, wherein in step f) hydrogen is fed in molar ratio with respect to CO₂ comprised between 3 and 5.5.

10. The process according to claim 1, wherein the process comprises a step g) of de-watering wet syngas coming from step e) for splitting H₂O from the syngas.

11. The process according to claim 10 wherein dry syngas has a ratio H2/CO ranging from 3.0 to 5.5.

12. A plant for producing syngas with the process according to claim 1, comprising:
a burner unit (OXY STEAM COMB.);
a solid electrolytic cell (SOEC)
a reverse water gas shift reactive unit (RWGS),
wherein
i. the burner unit (OXY STEAM COMB.) is connected to the reverse water gas shift reactive unit (RWGS) through a waste heat boiler (Boiler) and a water condensation unit (De-wa1);
ii. the solid electrolytic cell unit (SOEC) is connected to the reverse water gas shift reactive unit (RWGS) through a splitting unit (SEP) of oxygen from wet hydrogen and a further water condensation unit (De-waH2) placed downstream the SOEC.
